(19) United States
(12) Patent Application Publication
(10) Pub. No.: US 2026/0146344 A1
(43) Pub. Date: May 28, 2026

(54) HYDROGEN PRODUCTION UNIT HAVING SOLID OXIDE ELECTROLYZER CELLS (SOECs) USING PROTON EXCHANGE MEMBRANE (PEM) FUEL CELLS

(71) Applicant: Honda Motor Co., Ltd., Tokyo (JP)

(72) Inventor: David Perzynski, Signal Hill, CA (US)

(73) Assignee: Honda Motor Co., Ltd., Tokyo (JP)

(21) Appl. No.: 18/957,692

(22) Filed: Nov. 23, 2024

(51) Int. Cl. C25B 9/65; C25B 9/70; C25B 13/07; H01M 8/0656; H01M 8/10

(52) U.S. Cl. CPC C25B 9/65; C25B 9/70; C25B 13/07; H01M 8/0656; H01M 2008/1095

(57) ABSTRACT

A green hydrogen production unit may have at least one solid oxide electrolyzer cell (SOEC) to generate hydrogen gas from water by electrolysis. A green power supply may be coupled to the at least one SOEC. A green back-up power supply may be coupled to the at least one SOEC.

### BACKGROUND

Solid oxide electrolyzer cells (SOECs) are electrochemical devices that may work at high temperatures for electrolysis purposes. In general, SOECs may operate between the temperatures of 500° C. to 850° C.

SOECs may have a solid-state structure with a solid ceramic electrolyte material sandwich between an anode and a cathode. Driven by electricity, an oxidant, H₂O, may be reduced in the cathode, where a fuel, H₂, may be generated together with O²⁻ions. The O²⁻ ions may be transported through the electrolyte to the anode, where O₂ is formed through oxygen evolution reaction (OER) and electrons may be released.

SOECs may be used for the creation of “Green Energy” allowing for clean energy storage by converting excess power into hydrogen fuel. However, SOECs may require a minimum amount of power to maintain their operation, even during energy shortages. Without sufficient power, the SOEC's temperature may decrease. The lower temperature may reduce the efficiency of the electrochemical reactions. Insufficient power may lead to reduced electrochemical activity. Insufficient power may lead to material degradation.

SOECs may be powered through renewable energy sources such as solar and wind. This may allow SOECs to qualify for a tax credit for production of clean hydrogen. However, renewable energy sources, such as solar and wind, may provide variable levels of power. This variable power level may lead to intermittent power availability which may cause the SOEC's temperature to decrease which may lead to reduce efficiency of the electrochemical reactions/activity and material degradation. Traditional backup solutions such as diesel generators may compromise the “green” status of hydrogen production. Thus, it may be desirable to provide an SOEC that may take power from renewable energy sources to produce green hydrogen, and when renewable energy is unavailable, use a clean energy source as a power backup system for the SOEC.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a green hydrogen production unit is provided. The green hydrogen production unit may have at least one SOEC to generate hydrogen gas from water by electrolysis. A green power supply may be coupled to the at least one SOEC. A green back-up power supply may be coupled to the at least one SOEC.

According to another embodiment of the disclosure, a green hydrogen production unit is provided. The green hydrogen production unit may have at least one SOEC to generate hydrogen gas from water by electrolysis. A green power supply may be coupled to electrodes of the at least one SOEC generating power for the electrolysis. A green back-up power supply may be coupled to a hydrogen output and an oxygen output of the at least one SOEC.

According to an embodiment of the disclosure, a green hydrogen production unit is provided. The green hydrogen production unit may have a plurality of SOECs arranged in an array to generate hydrogen gas from water by electrolysis. A green power supply may be coupled to electrodes of each of the plurality of SOECs generating power for the electrolysis A green back-up power supply may be coupled to a hydrogen output and an oxygen output of the plurality of SOECs, wherein the green back-up power supply may be at least one proton exchange membrane (PEM) fuel cell.

### BRIEF DESCRIPTION OF THE DRAWINGS

FIG. 1 is a diagram of an exemplary green hydrogen production unit using a single SOEC having a green power back-up system in accordance with an embodiment of the disclosure; and

FIG. 2 is a diagram of an exemplary green hydrogen production unit using a plurality of SOECs having a green power back-up system in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

The present disclosure provides a green hydrogen production unit that may use a combination of a SOEC and a PEM fuel cell. The SOEC may take power from renewable energy sources to produce green hydrogen, and when the renewable energy is unavailable, the PEM fuel cell may be used as a power backup system for the SOEC. The PEM fuel cell may be powered by stored hydrogen that was produced by the SOEC during periods of excess renewable energy.

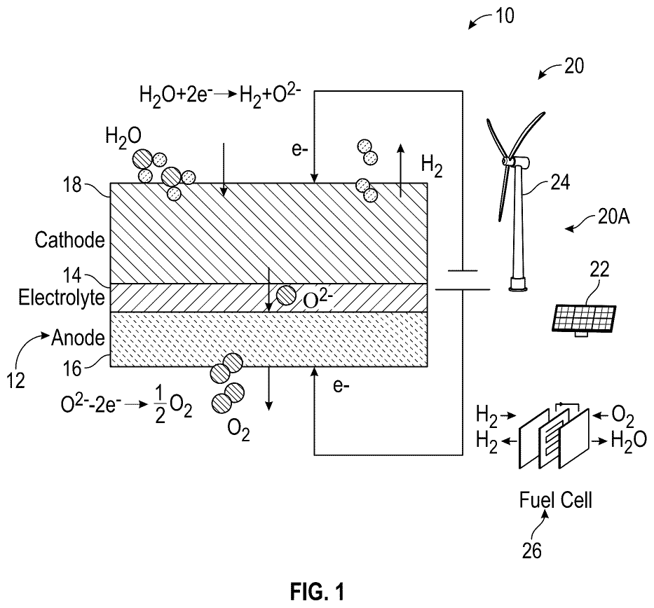

Referring to FIG. 1, a hydrogen production unit 10 (hereinafter unit 10) may be shown. In accordance with an embodiment, the unit 10 may be a green hydrogen production unit. The unit 10 may have a SOEC 12. The SOEC 12 may be a high-temperature electrochemical device that may split water into hydrogen and oxygen. The operating temperature of the SOEC 12 may be between 500° C. and 850° C.

The SOEC 12 may be a solid-state structure with an electrolyte material 14. The electrolyte material 14 may be a solid ceramic electrolyte material. In accordance with an embodiment, the electrolyte material 14 may be yttria stabilized zirconia (YSZ). YSZ may be a ceramic in which the cubic crystal structure of zirconium dioxide may be made stable at room temperature by the addition of yttrium oxide.

The electrolyte material 14 may be positioned between a pair of electrodes 16 and 18. In the SOEC 12, the electrode 16 may be an anode and the electrode 18 may be a cathode. In accordance with an embodiment, the electrode 16 may be called an air electrode, and the electrode 18 may be referred to as a fuel electrode.

A power supply 20 may be applied across the pair of electrodes 16 and 18. In accordance with an embodiment, the power supply 20 may be a green power supply 20A. For example, the green power supply 20A may be one of more solar panels 22, one or more wind turbines 24, or other similar green power sources.

In operation, when a positive potential is applied to the electrode 16, water in the fuel stream may be reduced (H₂O+2e→O⁻²+H₂) to form H₂ gas and O⁻² ions. The O⁻² ions may be transported through the solid electrolyte material 14, and then oxidized on the air side (2O⁻²→O₂) to produce molecular oxygen O₂.

The green power supply 20A, such as the one of more solar panels 22 or the one or more wind turbines 24, may provide variable levels of power, leading to intermittent power availability which may cause the temperature of the SOEC 12 to decrease which may lead to reduce efficiency of the electrochemical reactions/activity and material degradation. Traditionally, backup power supplies such as diesel generators may have been used. However, using diesel generators or other fossil fuel backup power supplies may compromise the “green” status of hydrogen production. Thus, the unit 10 may use one or more PEM fuel cells 26. The PEM fuel cell 26 may be a device that generates electricity by converting the chemical energy of hydrogen and oxygen into electricity. The PEM fuel cell 26 may be coupled to the H₂ and O₂ outputs of the SOEC 12. In operation, the SOEC 12 may take power from the green power supply 20A to produce green hydrogen, and when the green power supply 20A is unavailable, the PEM fuel cell 26 may be used as a power backup system for the SOEC 12. The PEM fuel cell 26 may be powered by stored hydrogen that was produced by the SOEC 12 during periods of excess renewable energy.

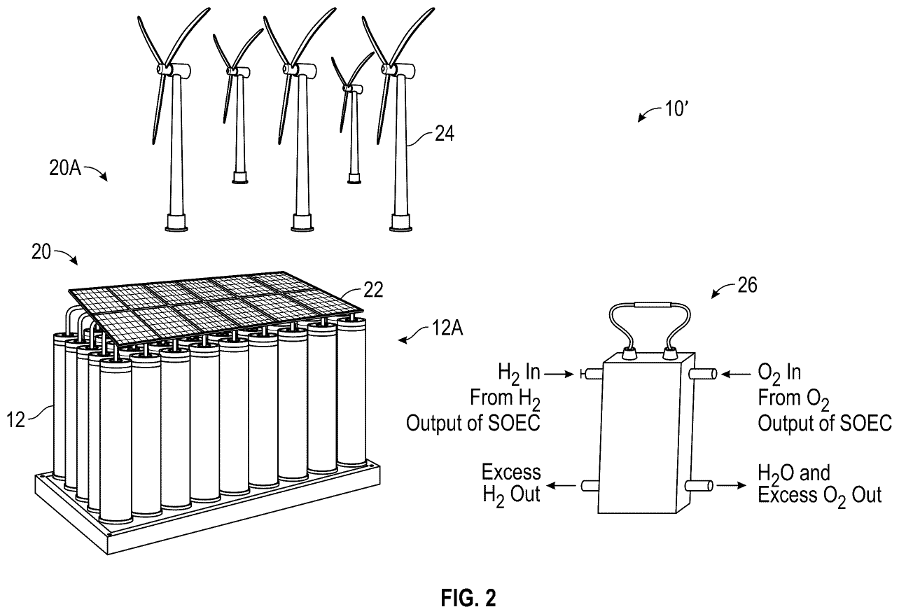

Referring to FIG. 2, another embodiment of the hydrogen production unit 10′ (hereinafter unit 10′) may be shown. In accordance with an embodiment, the unit 10′ may be a green a hydrogen production unit. The unit 10′ may have a plurality of SOECs 12. The SOECs 12 may be arranged in an array 12A. The SOECs 12 may be high-temperature electrochemical devices that may split water into hydrogen and oxygen. The operating temperature of each SOEC 12 may be between 500° C. and 850° C.

The SOECs 12 may be solid-state structures wherein each SOEC 12 may have an electrolyte material 14 (FIG. 1). The electrolyte material 14 of each SOEC 12 may be a solid ceramic electrolyte material. In accordance with an embodiment, the electrolyte material 14 may be yttria stabilized zirconia (YSZ). YSZ may be a ceramic in which the cubic crystal structure of zirconium dioxide may be made stable at room temperature by the addition of yttrium oxide.

The electrolyte material 14 of each SOEC 12 may be positioned between a pair of electrodes 16 (FIGS. 1) and 18 (FIG. 1). In each of the SOEC 12, the electrode 16 may be an anode and the electrode 18 may be a cathode. In accordance with an embodiment, the electrode 16 may be called an air electrode, and the electrode 18 may be referred to as a fuel electrode.

A power supply 20 may be coupled to the array of SOECs 12. The power supply 20 may be applied across the pair of electrodes 16 and 18 of each SOEC 12. In accordance with an embodiment, the power supply 20 may be a green power supply 20A. For example, the green power supply 20A may be one of more solar panels 22, one or more wind turbines 24, or other similar green power sources.

In operation, when a positive potential is applied to the electrodes 16, water in the fuel stream may be reduced (H₂O+2e→O⁻²+H₂) to form H₂ gas and O⁻² ions. The O⁻² ions may be transported through the electrolyte materials 14, and then oxidized on the air side (2O⁻²→O₂) to produce molecular oxygen O₂.

The green power supply 20A, such as the one of more solar panels 22 or the one or more wind turbines 24, may provide variable levels of power, leading to intermittent power availability which may cause the temperature of the SOECs 12 to decrease which may lead to reduce efficiency of the electrochemical reactions/activity and material degradation. Traditionally, backup power supplies such as diesel generators may have been used. However, using diesel generators or other fossil fuel backup power supplies may compromise the “green” status of hydrogen production. Thus, the unit 10′ may use one or more PEM fuel cells 26. The PEM fuel cells 26 may be a device that generates electricity by converting the chemical energy of hydrogen and oxygen into electricity. The PEM fuel cells 26 may be coupled to the H₂ and O₂ outputs of the array of SOECs 12. In operation, the SOECs 12 may take power from the green power supply 20A to produce green hydrogen, and when the green power supply 20A is unavailable, the PEM fuel cells 26 may be used as a power backup system for the SOECs 12. The PEM fuel cells 26 may be powered by stored hydrogen that was produced by the array of SOECs 12 during periods of excess renewable energy.

The units 10 and 10′ may provide a green hydrogen production unit that may use a combination of SOECs 12 and PEM fuel cells 26. The SOECs 12 may take power from renewable energy sources to produce green hydrogen, and when the renewable energy is unavailable, the PEM fuel cells 26 may be used as a power backup system for the SOECs 12. The PEM fuel cells 26 may be powered by stored hydrogen that was produced by the SOECs 12 during periods of excess renewable energy.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiments disclosed, but that the present disclosure will include all embodiments that fall within the scope of the appended claims.

1. A green hydrogen production unit, comprising:
at least one solid oxide electrolyzer cell (SOEC) to generate hydrogen gas from water by electrolysis;
a green power supply coupled to the at least one SOEC; and
a green back-up power supply coupled to the at least one SOEC.

2. The green hydrogen production unit of claim 1, wherein the green back-up power supply is coupled to a hydrogen gas output and an oxygen gas output of the SOEC.

3. The green hydrogen production unit of claim 1, wherein the green back-up power supply is at least one proton exchange membrane (PEM) fuel cell.

4. The green hydrogen production unit of claim 3, wherein the green back-up power supply is at least one PEM fuel cell coupled to a hydrogen gas output and an oxygen gas output of the SOEC.

5. The green hydrogen production unit of claim 1, wherein the green power supply is at least one solar panel.

6. The green hydrogen production unit of claim 1, wherein the green power supply is at least one wind turbine.

7. The green hydrogen production unit of claim 1, comprising a plurality of SOECs.

8. The green hydrogen production unit of claim 1, comprising a plurality of SOECs arranged in an array.

9. A green hydrogen production unit, comprising:
at least one solid oxide electrolyzer cell (SOEC) to generate hydrogen gas from water by electrolysis;
a green power supply coupled to electrodes of the at least one SOEC generating power for the electrolysis; and
a green back-up power supply coupled to a hydrogen output and an oxygen output of the at least one SOEC.

10. The green hydrogen production unit of claim 9, wherein the green back-up power supply is at least one proton exchange membrane (PEM) fuel cell.

11. The green hydrogen production unit of claim 10, wherein the at least one PEM fuel cell receives excess hydrogen gas from the SOEC.

12. The green hydrogen production unit of claim 9, wherein the green power supply is at least one solar panel.

13. The green hydrogen production unit of claim 9, wherein the green power supply is at least one wind turbine.

14. The green hydrogen production unit of claim 9, comprising a plurality of SOECs.

15. The green hydrogen production unit of claim 9, comprising a plurality of SOECs arranged in an array.

16. A green hydrogen production unit, comprising:
a plurality of solid oxide electrolyzer cells (SOEC) arranged in an array to generate hydrogen gas from water by electrolysis;
a green power supply coupled to electrodes of each of the plurality of SOECs generating power for the electrolysis; and
a green back-up power supply coupled to a hydrogen output and an oxygen output of the plurality of SOECs, wherein the green back-up power supply is at least one proton exchange membrane (PEM) fuel cell.

17. The green hydrogen production unit of claim 16, wherein the at least one PEM fuel cell receives excess hydrogen gas of the plurality of SOECs.

18. The green hydrogen production unit of claim 16, wherein the at least one PEM fuel cell receives excess hydrogen gas of the plurality of SOECs and powers the plurality of SOECs when the green power supply provides intermittent power.

19. The green hydrogen production unit of claim 16, wherein the green power supply is a plurality of solar panels.

20. The green hydrogen production unit of claim 16, wherein the green power supply is a plurality of wind turbines.
